(19) United States
(12) Patent Application Publication
(10) Pub. No.: US 2006/0009186 A1
(43) Pub. Date: Jan. 12, 2006

(54) Receiver front-end filtering using low pass filtering and equalization

(76) Inventors: Bin Liu, Danville, CA (US); Xi Huang, Freemont, CA (US)

Correspondence Address: Terry McHugh;Law Offices of Terry McHugh, 101 First Street, PMB 560, Los Altos, CA, 94022, US

(21) Appl. No.: 10/887,657

(22) Filed: Jul. 8, 2004

(51) Int. Cl. H04B 1/10; H04B 1/18

(52) U.S. Cl. 455/283; 455/302

(57) ABSTRACT

Signal processing for a receiver, such as a radio receiver within a cellular telephone, includes providing frequency conversion, preferentially passing a desired signal following the conversion, and introducing both phase-based filtering and equalization to the band-filtered signal. In one embodiment, the band filtering is provided by a low pass filter and the compensation occurs following operations by a polyphase filter, which implements the phase-based filtering. In many applications, the frequency conversion is a down conversion to either a zero intermediate frequency or a low intermediate frequency. The low pass filter reduces out-of-band interference and blocking signal strength, but may introduce phase-related distortions. The polyphase filtering and equalization cooperate to control the phase-related distortions.

### TECHNICAL FIELD

The invention relates generally to signal processing and more particularly to processing an input signal at a front-end of a wireless receiver.

### BACKGROUND ART

There are a number of concerns in the design of circuitry for the front-end of a receiver, particularly a receiver of a wireless communication device. The concerns include maintaining a high signal-to-interference and noise-ratio (SINR), controlling power consumption, reducing cost, and increasing miniaturization. Integrating a number of processing components onto a single integrated circuit chip using complementary metal oxide semiconductor (CMOS) techniques promotes all of miniaturization, low cost, and low power consumption. Achieving a target signal-to-interference and noise-ratio (SINR) requires paying close attention to regulating linearity, phase distortions, and a number of other factors.

For a wireless communication device, such as a cellular telephone or a pager, a radio frequency (RF) signal is typically received, filtered and frequency converted. A superheterodyne architecture is most commonly used. FIG. 1 illustrates conventional radio receiver architecture. An antenna 10 receives the RF signal and directs the signal to a first band pass filter (BPF) 12. From the first band pass filter, the signal is introduced to components of an integrated circuit chip, which is represented by box 14. A variable low noise amplifier (LNA) 16 provides amplification to the input signal, but adds only a low level of noise. A mixer 18 is sandwiched between a pair of off-chip band pass filters 20 and 22. It is typical to use surface acoustic wave (SAW) devices for the filters 12, 20 and 22. These SAW filters are bulky and not fabricated on the chip 14. The filters cooperate with the mixer to provide a filtered signal at an intermediate frequency (IF) lower than the RF signal. This intermediate frequency may be the difference between the frequency of the RF signal and the frequency of a local oscillator (LO) 24, which is regulated by a phase lock loop filter (PLLF) 26.

The signal is amplified at a variable gain amplifier 28 prior to being separated into an in-phase (I) component signal and a quadrature-phase (Q) component signal. The separation is provided by a synthesizer that includes a pair of mixers 30 and 32, a phase control block 34, and a second local oscillator 36, which is controlled by the PLLF block 26. The two component signals are passed through matched low pass filters (LPFs), thereby providing output signals along lines 42 and 44.

The superheterodyne architecture of FIG. 1 operates well for its intended purposes. In fact, performance is superior to many alternative architectures in many aspects, since the relatively high IF frequency allows the BPF 20 to reject the image signal. However, there are drawbacks. For example, the SAW filters 20 and 22 are bulky and expensive. As previously noted, the filters are off-chip components. This requires a relatively high driving capability from the chip. A 50 ohm load is typical. Thus, the power consumption tends to be higher than other available architectures.

Developments of highly integrated RF integrated circuits, particularly those implemented using CMOS RF integrated circuits, have led to other receiver architectures. Notable ones include low IF radio receivers and zero IF radio receivers. The zero IF receivers are also referred to as direct conversion receivers. In both cases, external SAW filters are eliminated, making the fully integrated radio integrated circuit possible. The potential problem of eliminating the external filters is that the on-chip circuits must have a higher dynamic range in order to handle the interference signals and blocking signals which are efficiently filtered out by the external filters 20 and 22 in the super-heterodyne receiver of FIG. 1.

A direct conversion receiver is shown in FIG. 2. Components which are functionally identical to those of FIG. 1 are provided with the same reference numerals. Thus, an RF signal is received at the antenna 10 and is passed through the band pass filter 12 for input to circuitry on an integrated circuit chip 46. A variable low noise amplifier 16 increases the signal strength of the RF signal prior to separation into I and Q component signals by operations of the mixers 30 and 32, the control 34, the local oscillator 36, and the phase lock loop filters 26. Merely by way of example, the local oscillator 36 may be fixed at 900 MHz if the received RF signal is at 900 MHz. As defined herein, an “intermediate frequency” includes the down-converted zero frequency of the receiver of FIG. 2.

The I and Q component of signals are directed through low pass filters 38 and 40 which filter out the unwanted band. A pair of variable gain amplifiers 48 and 50 may be included at the outputs of the signals from the integrated circuit chip 46.

An advantage of the direct conversion radio receiver of FIG. 2 is that it provides a simplified arrangement as compared to the receiver of FIG. 1. More importantly, the SAW filters are eliminated. However, the direct conversion receiver often requires some level of digital signal processing support, since the noise problem is more severe. There is also a DC offset problem. The DC offset concern is described and addressed in U.S. Pat. No. 6,504,884 to Zvonar. The solution described in the patent is to jointly (i.e., simultaneously) estimate the DC offset and the channel impulse response, and then reduce the DC offset in accordance with the joint estimations. The output of the mixer of the Zvonar receiver is passed through a low pass filter to remove higher-order harmonics from the mixing process. The resulting pass band signal is a train of bursts that is fed to an analog-to-digital converter (ADC). The ADC converts the modulation of the signal to corresponding digital data, which is processed in a subsequent data receiver having a digital signal processor (DSP). It is at the DSP that the DC offset is removed from the signal. The DSP also provides equalization, which is assisted by the joint estimations of DC offset and channel impulse response.

The low IF radio receiver architecture is shown in FIG. 3. Again, the same reference numerals are used for comparable components. In this receiver, the frequency of the local oscillator 36 is different than the received RF frequency. This difference determines the IF frequency of the receiver. As one possibility, the IF frequency may be 2 MHz, but this is not critical as long as it is low enough to be processed by the on-chip filters. The outputs of the mixers 30 and 32 are coupled in parallel to a polyphase band pass filter. Polyphase filters are used to provide channel selection. Such filters typically consist of a number of stages, with each stage having a complex pole followed by a gain. A polyphase filter acts to filter out-of-band signals from the outputs of the mixers. DC offset removal is also provided. The two component signals are then fed to variable gain amplifiers 54 and 56 prior to circuitry 58 for achieving de-rotation. Next, the signals are output from the integrated circuit chip 60.

Advantages of the low IF receiver of FIG. 3 include the elimination of the SAW filters of FIG. 1 and the reduction of the problem of DC component removal as compared to the architecture of FIG. 2. However, there are concerns with on-chip image rejection and control of flicker noise (1/f noise), especially in CMOS implementation. The IF frequency is selected partially on the basis of the requirements of subsequent filtering, particularly the complex filtering of the polyphase filter 52. Thus, there is a tradeoff between 1/f noise and signal requirements for enabling efficient filtering by subsequent components.

While the available approaches to providing signal processing at the front-end of a receiver achieve desirable results with regard to the combination of performance, power consumption, cost, and miniaturization, further developments are sought.

### SUMMARY OF THE INVENTION

In accordance with the invention, processing of an input signal at a front-end of a receiver includes preferentially passing a desired frequency band following a frequency conversion, introducing phase-based filtering to the band-filtered signal, and equalizing the signal. In a particular embodiment, the band filtering is provided by a low pass filter and the equalization occurs following at least one stage of the phase-based filtering, which may be provided by a multi-stage polyphase filter.

For wireless receivers that include a low noise amplifier and a mixer, the out-of-band blocking signal (blocker) may impose stringent linearity requirements for the subsequent stages, such as filters and variable gain amplifiers. However, the low pass filter of the present invention may be used to significantly reduce the out-of-band signal strength. The low pass filter should have a high linearity. However, while the low pass filter does not introduce significant amplitude-related distortions to the desired signal, it introduces phase-related distortions. In fact, the narrower the bandwidth of the low pass filter, the greater the level of such distortions. Nevertheless, when the equalizer is inserted as part of the receiver chain, the combined signal processing leads to desirable results.

The stages of the phase-based filtering, such as polyphase filtering, attenuate or eliminate intermodulation signals and interference signals. Consequently, it is possible to use an equalizer that exhibits a frequency response which is generally symmetrical about the intermediate frequency (whether a low IF or a zero IF) and that does not include the complexity of roll off at the ends of the desired frequency band. It follows that the equalizer will amplify any out-of-channel noise, but the noise level will be filtered out by the following phase-based filtering.

### BRIEF DESCRIPTION OF THE DRAWINGS

FIG. 1 is a block diagram of a prior art superheterodyne radio receiver having off-chip surface acoustic wave filters.

FIG. 2 is a block diagram of a prior art direct conversion (zero IF) radio receiver.

FIG. 3 is a block diagram of a prior art low IF radio receiver.

FIG. 4 is a block diagram of one embodiment of a low IF receiver having low pass filtering and equalization in accordance with the invention.

FIG. 5 is a representation of the in-band blocking signal levels specified in the GSM standard.

FIG. 6 is a representation of characteristics of adjacent channel interference signals in accordance with the GSM standard.

FIG. 7 is a graph of signal swings for a 3 MHz blocking signal prior to the low pass filter of FIG. 4.

FIG. 8 is a graph of signal swings for the 3 MHz blocking signal following passage through the low pass filter of FIG. 4.

FIG. 9 illustrates a frequency response for the distortion compensator of FIG. 4.

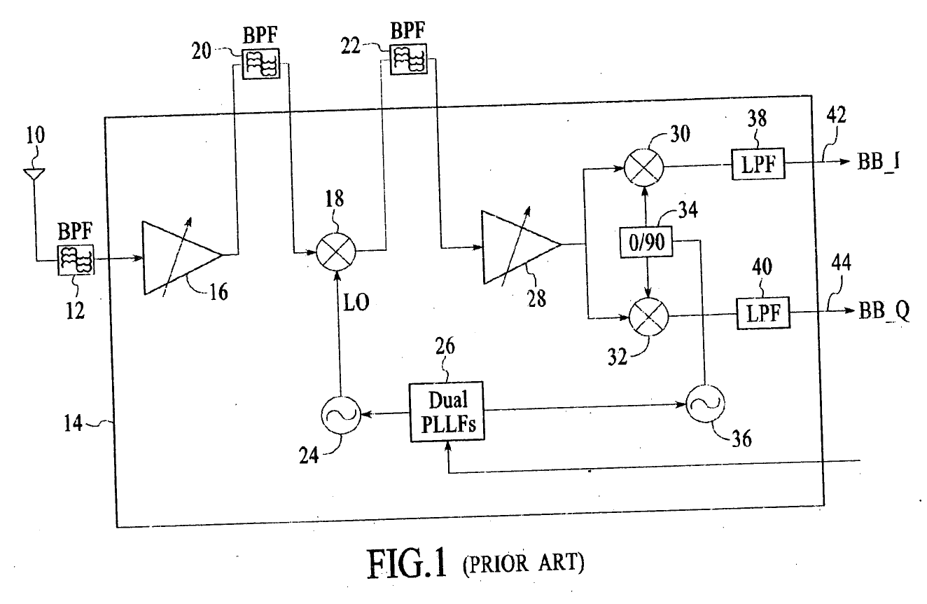

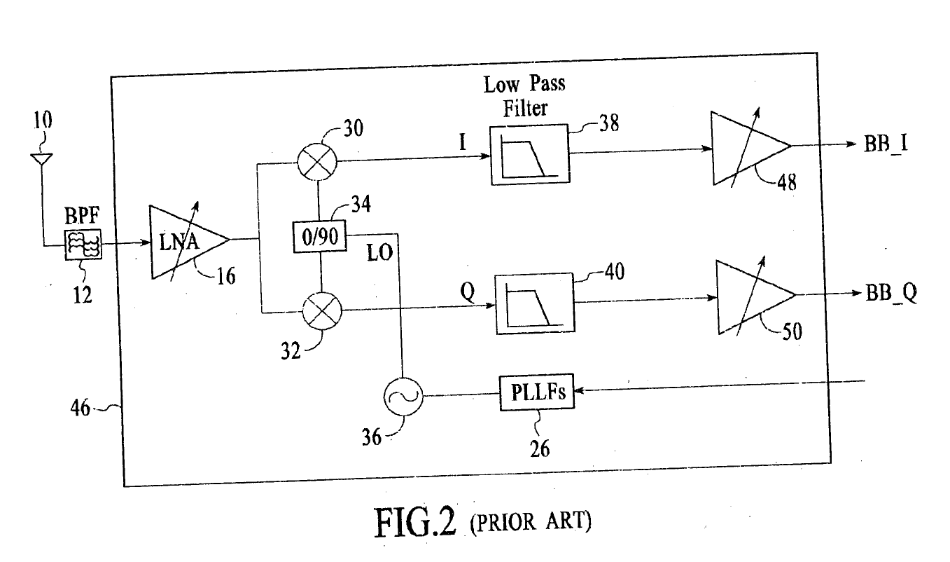

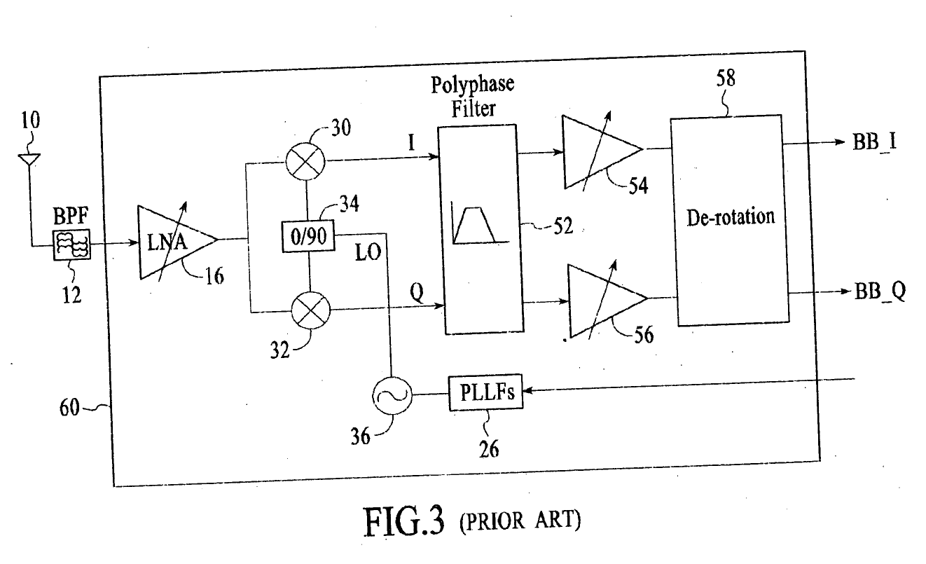

### DETAILED DESCRIPTION

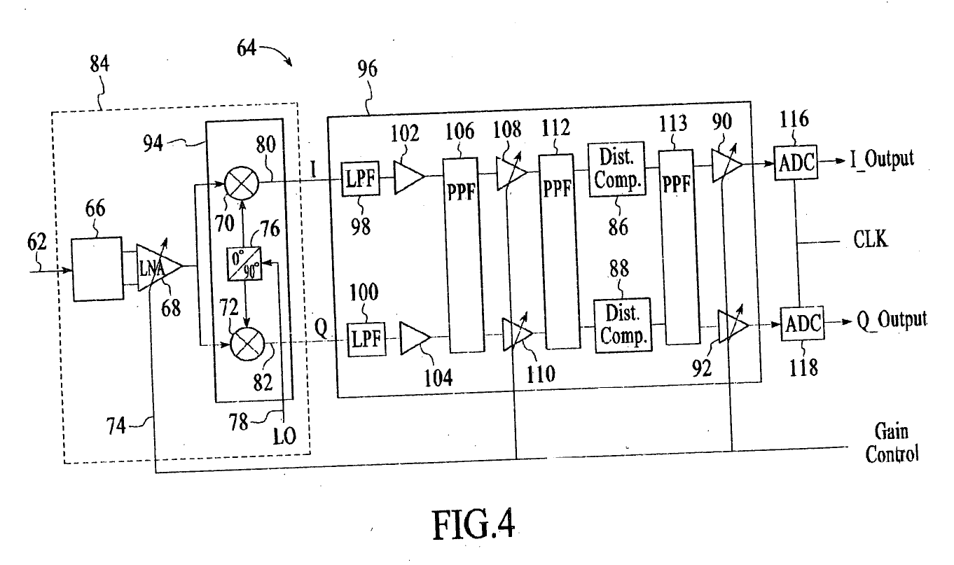

FIG. 4 illustrates one possible embodiment of the invention. While the signal processing will be described as being implemented with the global system for mobile communication (GSM) standard for wireless communications, a person of ordinary skill in the art will recognize that the invention may be adapted for use in other environments.

The input line 62 to the receiver 64 may be coupled to an antenna, not shown. The input line is linked to a switching arrangement 66, which may include a SAW filter or equivalent component, since the switching arrangement is not critical to the invention. The switching arrangement provides preliminary RF filtering.

A variable low noise filter 68 is a conventional component for the front-end of a wireless receiver. Such amplifiers function as band pass filters for initial channel selection. However, the more significant function of the amplifier is to ensure sufficient signal strength for reliable operation of the mixers 70 and 72 that follow. Within the GSM standard for cellular phones, the signal strength along the input line 62 from the antenna may be 102 dBm. A control line 74 to the low noise amplifier 68 is connected to gain control circuitry, not shown.

The mixers 70 and 72 receive inputs from the low noise amplifier 68 and from a phase control component 76 that is connected to a line 78 from the local oscillator. In the embodiment of FIG. 4, the receiver 64 is a low IF device. However, the invention may be used with zero IF or similar receivers. As outputs of the two mixers, there is a ninety degree phase difference between the in-phase (I) component signal on line 80 and the quadrature (Q) component signal on line 82.

The term “front-end circuitry” of a receiver is sometimes limited to those components contained within the dashed box 84 of FIG. 4. However, as used herein, the term includes components at least up to the pair of equalizers 86 and 88. In FIG. 4, the front-end circuitry also includes a pair of variable gain amplifiers 90 and 92. Also in FIG. 4, the components are integrated onto a pair of integrated circuit chips, as represented by rectangles 94 and 96. However, in other embodiments, the mixers 70 and 72 are fabricated on the same chip as the components within the rectangle 96.

The I and Q component signals from the mixers 70 and 72 are directed through matched low pass filters 98 and 100 and matched amplifiers 102 and 104. Essentially, the low pass filters reject the signals in the unwanted band and pass the signal in the desired band pass of the system. Low pass filters are characterized by sharp roll-offs following the cut-off frequencies. However, as will be explained below, while each low pass filter has high linearity and does not introduce significant amplitude-related distortions, the filter introduces phase-related distortions which must be addressed.

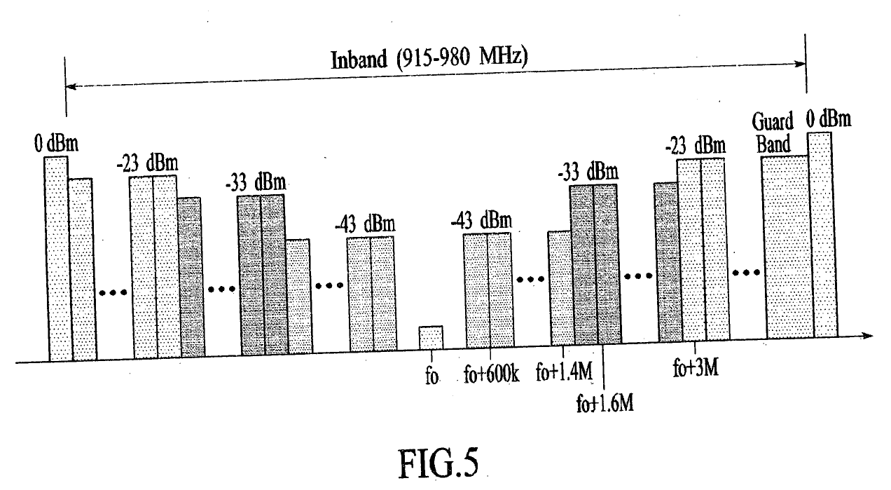

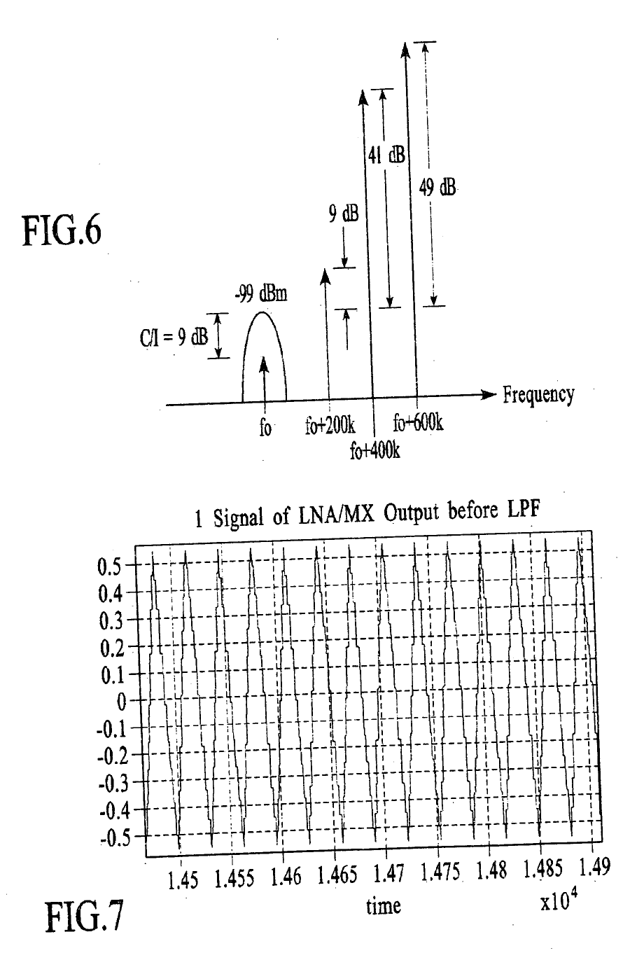

In considering the operations of the low pass filters 98 and 100, the 3 MHz blocking signal defined in the GSM standard will be isolated. The profile of blocking signals specified in the GSM standard is shown in FIG. 5. As can be seen, the maximum interference power at the 3 MHz offset from the target frequency (of) is −23 dBm. Also of interest is the adjacent channel interference signal information shown FIG. 6. The ratio of carrier power to interference power (C/I) is 9 dB. Stated differently, the minimum required signal-to-noise ratio defined in the GSM specification is 9 dB.

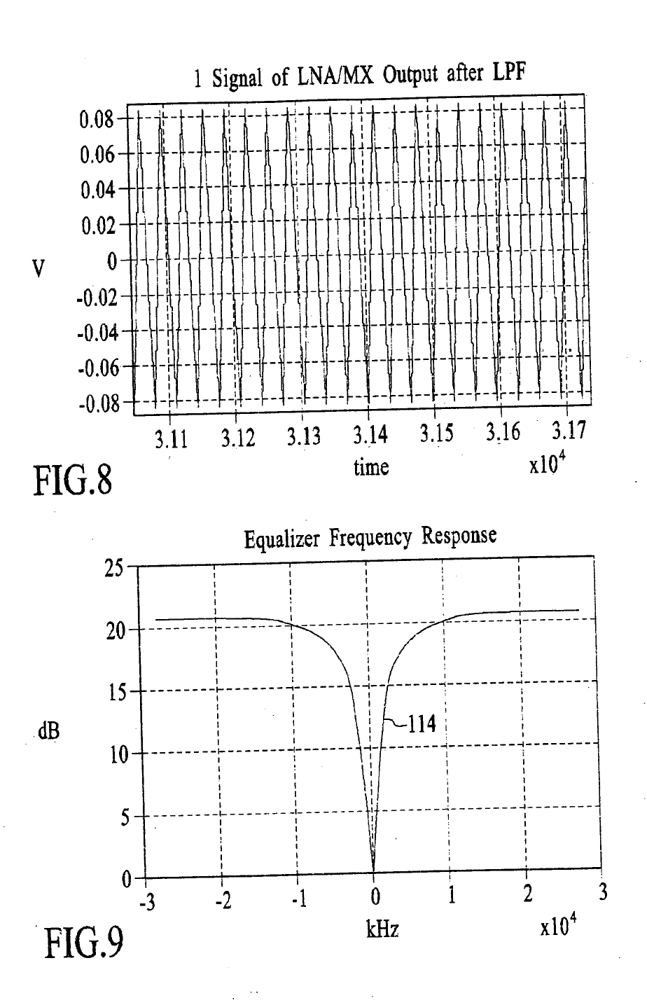

In FIG. 4, the I component signal from the mixer 70 will be conducted along line 80. In considering the 3 MHz blocking signal, the signal level along the line 80 will have a 1 volt swing, as indicated in FIG. 7. This signal level will pose stringent linearity requirements upon subsequent components. The low pass filters 98 and 100 are introduced at the outputs of the mixers 70 and 72 in order to reduce the signal strengths of the blocking signals. FIG. 8 shows the voltage swing of the 3 MHz signal following passage through the low pass filter 98. In comparing FIGS. 7 and 8, the voltage swing is reduced from more than 1 volt to less than 0.2 volts.

As one possibility for implementing the low pass filters 98 and 100, the devices may be passive filters comprising resistances and capacitances, although inductances may also be utilized in defining the bandwidth. An acceptable bandwidth is 500 kHz. However, other passive or active arrangements may be used in defining the low pass filters.

In the embodiment of FIG. 4, the amplifiers 102 and 104 are fixed gain stages. An acceptable level of gain is 12 dB, but this is not critical.

The outputs of the amplifiers 102 and 104 feed a polyphase filter 106. As one possibility, this component may be a first stage of a fifth order Butterworth device. As is known in the art, a polyphase filter is used to provide image rejection. In fact, the filter acts to remove a high percentage of all out-of-band signals in the outputs of the mixers 70 and 72. The polyphase filter also filters DC components, such as those resulting from leakage in the mixers.

From the first stage polyphase filter 106, the signals pass through variable gain amplifiers 108 and 110. By way of example, the variable gain amplifiers may be adjusted by the gain control circuitry (not shown) to vary within the range of 0 dB to 30 dB.

From the variable gain amplifiers 108 and 110, the I and Q component signals are directed to a second stage polyphase filter 112. The operations of the two stages of polyphase filtering cooperate to achieve high levels of channel selection, image rejection, and DC component removal.

While the low pass filters 98 and 100 exhibit high linearity and do not introduce significant amplitude-related distortions, the filters unfortunately introduce phase-related distortions. The narrower the band of the low pass filters, the greater the level of phase-related distortion. To combat this tendency, the circuitry of the receiver 64 includes paired distortion equalizers 86 and 88. Prior to reaching the equalizers, blocking signals, intermodulation signals, and interference signals are attenuated by the polyphase filter stages 106 and 112. Consequently, the equalizers have very little out-of-channel noise to amplify, so that simple and inexpensive equalizer circuits may be employed.

FIG. 9 illustrates the frequency response 114 of an equalizer, with the frequency response being symmetrical about the center frequency of the signal. Here, the center frequency is identified as being 0 kHz, but merely by example. This example would be best suited for a zero IF receiver. As can be seen, the frequency response is not tailored to include sharp roll-offs at the ends of the desired band. However, while the off-center tailoring of the frequency response is not a necessary element of the invention, there may be embodiments in which such tailoring provides a significant advantage. For example, if the out-of-channel removal of noise by the three stages of the polyphase filters 106 and 112 is not sufficient, the frequency response tailoring of the compensators would increase the overall performance of the receiver 64.

The equalizers 86 and 88 are followed by the final variable gain amplifiers 90 and 92. These amplifiers may be identical to variable gain amplifiers 102 and 104, so that the gain is dynamic over the range of 0 dB to 30 dB.

The signals from the variable gain amplifiers 90 and 92 are directed off-chip to a pair of analog-to-digital converters (ADCs) 116 and 118. The conversion starts processing which is considered to be separate from the portion of the receiver chain that is defined as the invention. Operations of the ADCs and subsequent circuitry are conventional and well known to persons of ordinary skill in the art.

While the equalizers 86 and 88 are shown as following the polyphase filtering, there may be advantages to providing equalization between stages of polyphase filtering. As another possible modification to the receiver 64 of FIG. 4, separate I and Q component signals are not critical.

What is claimed is:

1. A method of processing an input signal at a front-end of a receiver comprising:
converting said input signal to at least one frequency-converted signal having information of interest, including outputting a first frequency-converted signal;
band filtering said first frequency-converted signal to preferentially pass a desired band and to provide rejection in bands outside said desired band, thereby providing a band-filtered signal;
introducing phase-based filtering to said band-filtered signal; and
providing equalization within said desired band following said first phase-based filtering.

2. The method of claim 1 wherein said phase-based filtering includes utilizing at least one stage of a polyphase filter, wherein group delay characteristics of said stages of said polyphase filter are tailored to provide channel selection and image rejection within said band-filtered signal.

3. The method of claim 1 wherein said band filtering includes introducing said first frequency-converted signal to a low pass filter.

4. The method of claim 3 wherein said low pass filter has a bandwidth in the range of 400 kHz to 600 kHz for IF frequency of 100 kHz and signal band width of 200 kHz.

5. The method of claim 1 wherein said equalization has amplification characteristics that are tailored to a target frequency of said first frequency-converted signal and to distortion characteristics of said band filtering, said equalization being implemented prior to a conversion of said input signal from an analog state to a digital state.

6. The method of claim 1 wherein said converting generates said first frequency-converted signal as an in-phase (I) signal component and generates a second frequency-converted signal as a quadrature-phase (Q) signal component.

7. The method of claim 1 wherein said converting is configured to convert an input radio frequency (RF) signal to one of a low intermediate frequency (low IF) or a zero intermediate frequency (ZIF).

8. The method of claim 7 wherein said band filtering, said first phase-based filtering and said equalization are implemented in complementary metal oxide semiconductor (CMOS) circuitry fabricated on a single chip.

9. A receiver for a communications device comprising:
circuitry for receiving and manipulating an input signal to provide at least one modulated signal;
a low pass filter connected to preferentially pass a desired band of said modulated signal;
a channel-selection filter connected to receive said modulated signal from said low pass filter, said channel-selection filter being configured to provide rejection of signals outside a target channel; and
an equalizer operatively associated with said channel-selection filter to remove distortion introduced into said desired channel.

10. The receiver of claim 9 wherein said circuitry for receiving and manipulating includes a mixer configured to generate an I component signal and a Q component signal, said I and Q component signals being said at least one modulated signal, said mixer being specific to one of a low IF or a zero IF.

11. The receiver of claim 10 wherein said equalizer has a frequency response that is generally symmetrical about said low IF or zero IF to which said mixer is specific.

12. The receiver of claim 11 further comprising an analog-to-digital converter connected to receive signal information following said channel-selection filter and equalizer.

13. The receiver of claim 9 wherein said channel-selection filter is a multi-stage polyphase filter and wherein said equalizer is coupled between a pre-equalization stage and post-equalization stage of said polyphase filter.

14. The receiver of claim 9 wherein said low pass filter, said channel-selection filter, said equalizer and said circuitry for receiving and manipulating are housed within a cellular telephone.

15. A processing method for a receiver of wireless communications comprising:
mixing an input signal and a local oscillator to form a mixer output signal, said input signal being an analog signal;
utilizing low pass filtering to reduce signal strengths of said input signal outside a specific bandwidth, thereby providing a low pass filtered signal;
applying channel selection to said low pass filtered signal; and
introducing compensation to said low pass filtered signal following said channel selection, said low pass filter being an analog signal following said equalization.

16. The processing method of claim 15 wherein said equalization has generally symmetrical amplification characteristics about an intermediate frequency (IF) of said mixer output signal, said IF being one of a low IF or a zero IF.

17. The processing method of claim 16 further comprising a step of tailoring said amplification characteristics to achieve compensation for phase-related distortions introduced in said low pass filtering.

18. The processing method of claim 15 wherein said channel selection includes utilizing at least one stage of a polyphase filter (PPF).

19. The processing method of claim 18 wherein said PPF is integrated onto a single chip with circuitry for implementing said low pass filtering and said equalization.
